(19) United States
(12) Patent Application Publication
(10) Pub. No.: US 2022/0277221 A1
(43) Pub. Date: Sep. 1, 2022

(54) SYSTEM AND METHOD FOR IMPROVING MACHINE LEARNING TRAINING DATA QUALITY

(71) Applicant: Samsung Electronics Co., Ltd., Suwon-si (KR)

(72) Inventors: Tapas Kanungo, Redmond, WA (US); Nehal Bengre, Mountain View, CA (US); Stephen Walsh, Sunnyvale, CA (US); Pingjie Tang, Granger, IN (US)

(21) Appl. No.: 17/405,875

(22) Filed: Aug. 18, 2021

Related U.S. Application Data
(60) Provisional application No. 63/154,402, filed on Feb. 26, 2021.

(51) Int. Cl. G06N 20/00; G06N 5/04

(52) U.S. Cl. CPC G06N 20/00; G06N 5/04

(57) ABSTRACT

A method includes generating, using at least one processor of an electronic device, a plurality of expert labels for a sample using a plurality of machine learned classifiers. The method also includes determining, using the at least one processor, an expert consensus label among the plurality of expert labels. The method further includes comparing, using the at least one processor, the expert consensus label to a ground truth label associated with the sample in response to determining that a consensus is found among the plurality of machine learned classifiers. The method also includes identifying, using the at least one processor, the ground truth label as a clean label in response to determining that the expert consensus label and the ground truth label match. In addition, the method includes identifying, using the at least one processor, the ground truth label for reassessment in response to determining that the expert consensus label and the ground truth label do not match.

### CROSS-REFERENCE TO RELATED APPLICATION AND PRIORITY CLAIM

This application claims priority under 35 U.S.C. § 119(e) to U.S. Provisional Patent Application No. 63/154,402 filed on Feb. 26, 2021, which is hereby incorporated by reference in its entirety.

### TECHNICAL FIELD

This disclosure relates generally to machine learning systems. More specifically, this disclosure relates to a system and method for improving machine learning training data quality.

### BACKGROUND

Ground truth labels are very important to most artificial intelligence (AI) projects. However, the process of manually generating ground truth labels can be tedious, time-consuming, prohibitively expensive, and potentially inaccurate. Also, ground truth label quality can be low due to poor guidelines (such as when defined classes are ambiguous or overlapping), poor grader training (such as when a trainer does not know descriptions of one or more classes or is not aware of the existence of one or more labels), or simply carelessness of the grader.

### SUMMARY

This disclosure provides a system and method for improving machine learning training data quality.

In a first embodiment, a method includes generating, using at least one processor of an electronic device, a plurality of expert labels for a sample using a plurality of machine learned classifiers. The method also includes determining, using the at least one processor, an expert consensus label among the plurality of expert labels. The method further includes comparing, using the at least one processor, the expert consensus label to a ground truth label associated with the sample in response to determining that a consensus is found among the plurality of machine learned classifiers. The method also includes identifying, using the at least one processor, the ground truth label as a clean label in response to determining that the expert consensus label and the ground truth label match. In addition, the method includes identifying, using the at least one processor, the ground truth label for reassessment in response to determining that the expert consensus label and the ground truth label do not match.

In a second embodiment, an electronic device includes at least one memory configured to store instructions. The electronic device also includes at least one processing device configured when executing the instructions to generate a plurality of expert labels for a sample using a plurality of machine learned classifiers. The at least one processing device is also configured when executing the instructions to determine an expert consensus label among the plurality of expert labels. The at least one processing device is further configured when executing the instructions to compare the expert consensus label to a ground truth label associated with the sample in response to determining that a consensus is found among the plurality of machine learned classifiers. The at least one processing device is also configured when executing the instructions to identify the ground truth label as a clean label in response to determining that the expert consensus label and the ground truth label match. In addition, the at least one processing device is configured when executing the instructions to identify the ground truth label for reassessment in response to determining that the expert consensus label and the ground truth label do not match.

In a third embodiment, a non-transitory machine-readable medium contains instructions that when executed cause at least one processor of an electronic device to generate a plurality of expert labels for a sample using a plurality of machine learned classifiers. The medium also contains instructions that when executed cause the at least one processor to determine an expert consensus label among the plurality of expert labels. The medium further contains instructions that when executed cause the at least one processor to compare the expert consensus label to a ground truth label associated with the sample in response to determining that a consensus is found among the plurality of machine learned classifiers. The medium also contains instructions that when executed cause the at least one processor to identify the ground truth label as a clean label in response to determining that the expert consensus label and the ground truth label match. In addition, the medium contains instructions that when executed cause the at least one processor to identify the ground truth label for reassessment in response to determining that the expert consensus label and the ground truth label do not match.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIGS. 2A and 2B illustrate an example process for improving machine learning training data quality according to this disclosure;

FIG. 3 illustrates example results obtained during an implementation of the process of FIGS. 2A and 2B according to this disclosure; and

FIG. 4 illustrates an example method for improving machine learning training data quality according to this disclosure.

### DETAILED DESCRIPTION

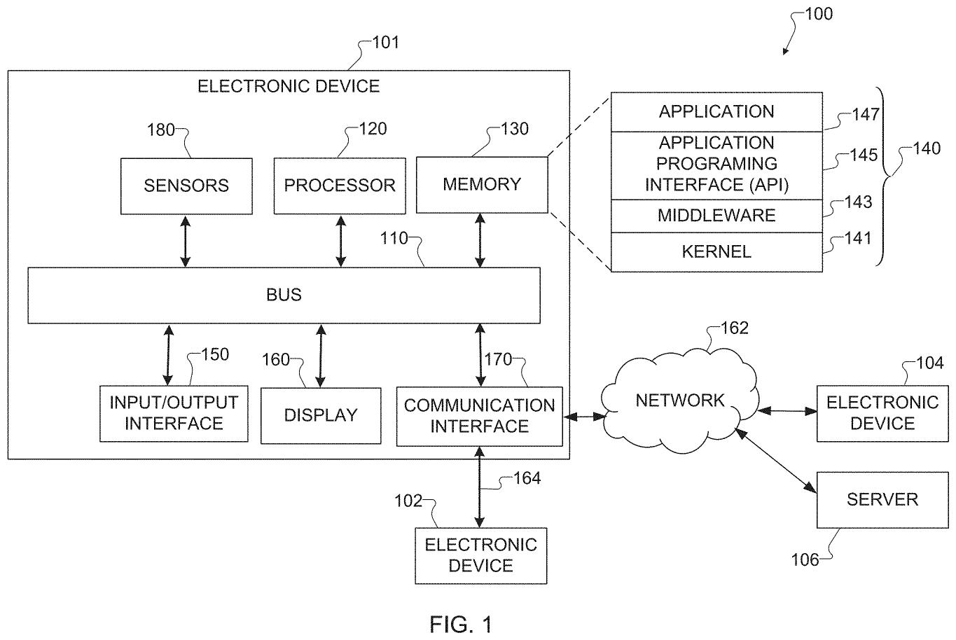

FIGS. 1 through 4, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As noted above, ground truth labels are very important to most artificial intelligence (AI) projects. However, the process of manually generating ground truth labels can be tedious, time-consuming, prohibitively expensive, and potentially inaccurate. Also, ground truth label quality can be low due to poor guidelines (such as when defined classes are ambiguous or overlapping), poor grader training (such as when a trainer does not know descriptions of one or more classes or is not aware of the existence of one or more labels), or simply carelessness of the grader.

One approach for generating ground truth labels involves using multiple graders per data sample in order to improve label quality. However, this is typically a very expensive and time-consuming process. Another approach for generating ground truth labels involves using multiple graders per sample and determining the level of uncertainty in the ground truth labels. However, this technique does not improve the quality of the ground truth labels. This technique is sometimes modified so that a first grader is actually the classifier that is being trained, and any disagreements are resolved by a second grader. Unfortunately, this leads to labels that are biased towards the classifier being trained.

This disclosure provides systems and methods for improving machine learning training data quality. The disclosed systems and methods build and train a variety of machine learned classifiers or “experts” to provide alternate viewpoints and proposed ground truth labels. The disclosed systems and methods use a degree of mismatch between the experts and an agreement between the experts and the ground truth labels to determine one or more outcomes for the training data. Depending on the outcome, one or more guidelines may need to be fixed, the ground truth labels may be accepted as clean data, or the ground truth labels may need regrading after the guidelines are fixed. Note that while some of the embodiments discussed below are described in the context of neural networks, this is merely one example, and it will be understood that the principles of this disclosure may be implemented in any number of other suitable contexts.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described in more detail below, the processor 120 may perform one or more operations to improve machine learning training data quality.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for improving machine learning training data quality as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support improving machine learning training data quality.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

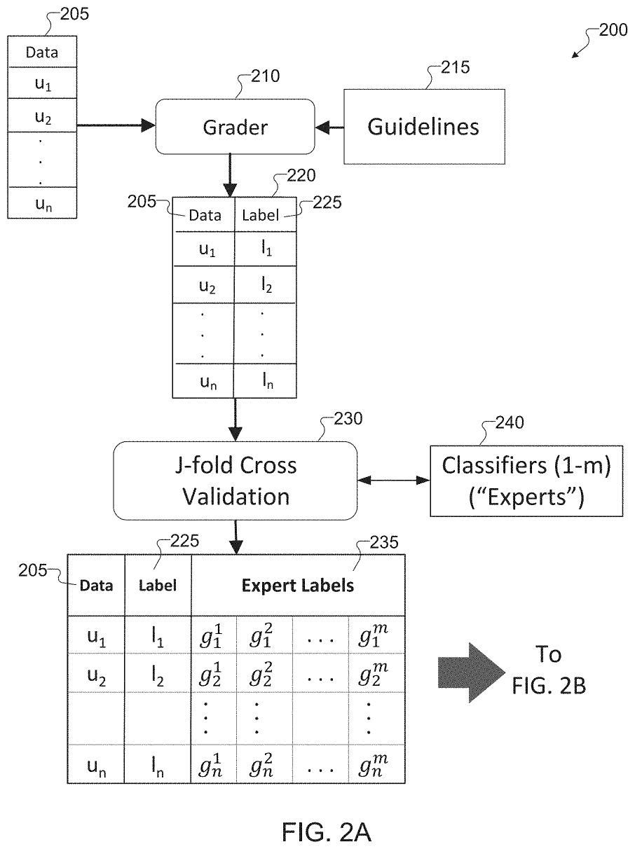

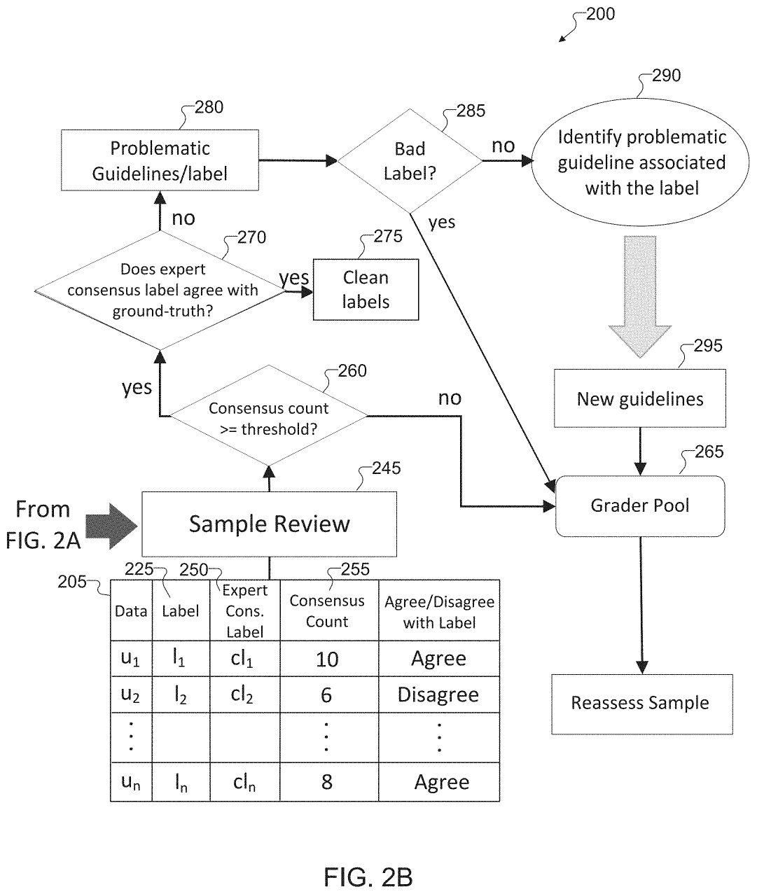

FIGS. 2A and 2B illustrate an example process 200 for improving machine learning training data quality according to this disclosure. For ease of explanation, the process 200 is described as being implemented in the electronic device 101 shown in FIG. 1. However, the process 200 could be implemented in any other suitable electronic device (such as the server 106 of FIG. 1) and in any other suitable system.

As shown in FIGS. 2A and 2B, the process 200 receives and processes input data 220 to generate clean labels 275 that can be used for training one or more machine learning models, such as a neural network. The electronic device 101 can obtain the input data 220, which is to be processed using the process 200, from any suitable source(s). In this example, the input data 220 includes multiple data samples 205 (denoted u₁, u₂, . . . , uₙ) and multiple corresponding labels 225 (denoted l₁, l₂, . . . , lₙ). In some embodiments, the input data 220 is generated using a manual grading process in which a grader 210 receives and grades multiple data samples 205 using multiple guidelines 215. In some cases, each of the data samples 205 may represent a verbal utterance, such as “What is the weather like today?” In particular embodiments, each utterance represents a command or question that a user might speak to a virtual assistant. However, this is merely one example, and the data samples 205 can represent other suitable type(s) of data.

During the grading process (sometimes referred to as “ground truthing”), the grader 210 (such as a human grader) examines each of the data samples 205 and uses the guidelines 215 to assign a corresponding label 225 to the data sample 205. The labels 225 represent ground truth labels that can be used in a subsequent machine learning training process. As shown here, there is one label 225 for each data sample 205. However, this is merely one example, and one or more of the data samples 205 may be assigned more than one label 225.

The guidelines 215 guide or assist the grader 210 in determining how to grade or classify a data sample 205 based on its content. For example, utterances (such as “What is the weather like today?”) can be classified into one or more predefined classes or “skills” (such as weather, time, food, email, and the like). The guidelines 215 can be used to answer questions such as “What does the ‘weather’ skill do?” or “What are related topics associated with the ‘weather’ skill?” Initially, the guidelines 215 may be of poor quality, or there may be no guidelines 215 to guide the grader 210 while grading the data samples 205. As a result, during the grading process, the grader 210 may make a mistake based on poor-quality or nonexistent guidelines 215. Thus, the labels 225 may not be of very high quality.

The electronic device 101 receives and processes the input data 220, such as by using a J-fold cross validation process 230, to generate multiple expert labels 235. In a J-fold cross validation process 230, multiple machine learned classifiers 240, referred to as “experts,” are built and trained. During the training, the experts 240 estimate or predict the expert labels 235 for each of the data samples 205. As shown in FIG. 2A, the expert labels 235 are identified as g₁¹ through gₙ^{m}. The superscript (1 through m) represents a particular one of m experts 240. Here, m could be any integer greater than one. The expert labels g₁¹ through g₁^{m} are the m expert labels estimated by the m experts 240, respectively, for the data sample 205 identified as u₁. In essence, the experts 240 generate the expert labels 235 similar to the process of the human grader 210 in generating the labels 225 for the data samples 205.

In some embodiments, the experts 240 represent diverse types of AI classifiers. For example, different experts 240 may represent a random forest classifier, a gradient boosted classifier, a support vector machine classifier, or any other suitable types of classifiers. The experts 240 can be selected to complement each other and reduce bias in label generation, and using different types of classifiers can help reduce the bias.

The J-fold cross validation process 230 uses an iterative technique in which n data samples 205 (u₁, u₂, . . . , uₙ) are divided into J buckets. In the following explanation, it is assumed that J=10 and n=1000. Thus, each of the ten buckets includes one hundred data samples 205. However, this is merely one example, and other numbers of buckets and data samples 205 could be used. During each iteration of the J-fold cross validation process 230, nine of the ten buckets are used for training in order to predict the expert labels 235 for the remaining bucket. For example, in a first iteration, the experts 240 may be trained using the second through tenth buckets (data samples u₁₀₁-u₁₀₀₀), and the trained experts 240 generate expert labels 235 (g₁¹-g₁^{m}, g₂¹-g₂^{m}, . . . , g₁₀₀¹-g₁₀₀^{m}) for the first bucket of one hundred data samples 205. In the next iteration, the experts 240 may be trained using the first bucket and the third through tenth buckets, and the trained experts 240 generate expert labels 235 (g₁₀₁¹-g₁₀₁^{m}, g₁₀₂¹-g₁₀₂^{m}, . . . , g₂₀₀¹-g₂₀₀^{m}) for the second bucket of one hundred data samples 205. Additional iterations can be performed until the expert labels 235 are generated for the tenth bucket of data samples 205.

Turning to FIG. 2B, all of the data output from the J-fold cross validation process 230 (such as the data samples 205, the labels 225, and the expert labels 235) can be compiled and reviewed in a sample review process 245. It is noted that the expert labels 235, once generated, may or may not agree with the corresponding labels 225. In the sample review process 245, the electronic device 101 determines how many of the experts 240 agree or disagree with each other and with the human grader 210. For example, each of the expert labels g₁¹-g₁^{m} may or may not agree with the corresponding label l₁. The quantity of experts 240 forming the largest group of experts 240 that agree with each other is tallied as a consensus count 255, and the expert label 235 on which the largest group of experts 240 agree is deemed to be an expert consensus label 250 (indicated as cl₁). As a particular example, it may be determined that, for the data sample u₁ (such as “What is the weather like today?”), the label l₁ determined by the grader 210 is “weather.” It may also be assumed that there are twenty experts 240 (m=20) and that six of the expert labels g₁^{x} (as determined by six experts 240) are “time”, four of the expert labels g₁^{x} are “calendar”, and ten of the expert labels g₁^{x} are “weather.” Since the largest group of experts 240 that agree with each other is ten, the consensus count 255 is ten, and the expert consensus label 250 (cl₁) is “weather.”

Once the expert consensus labels 250 are determined, the electronic device 101 performs a comparison operation 260 to determine if the consensus count 255 is at least a threshold value. The threshold value represents a minimum number of experts 240 that need to be in agreement for the expert consensus label 250 to be useful. The threshold value is used since there may be wide disagreement among the experts 240 such that the consensus count 255 is small (like only four out of twenty), in which case it may be determined that there is a lack of consensus among the experts 240 and that the data sample 205 has too much noise. The threshold value can be any suitable value and may be determined empirically. If the consensus count 255 is less than the threshold value, the data sample 205 is considered noisy and is marked to be returned to a grader pool 265 where a grader 210 can reassess the data sample 205.

If the electronic device 101 determines in the comparison operation 260 that the consensus count 255 exceeds the threshold value, the electronic device 101 performs another comparison operation 270 to determine if the expert consensus label 250 is in agreement with the label 225. In the example shown in FIG. 2B, the label l₁ is “weather” and the expert consensus label cl₁ is “weather,” so the expert consensus label 250 is in agreement with the label 225.

If the expert consensus label 250 and the label 225 are in agreement, the label 225 is considered to be a clean label 275, and the label 225 is marked or stored in a manner so that it can be included in a training set as a clean label 275 for subsequent training. If the expert consensus label 250 and the label 225 are not in agreement, the electronic device 101 determines at step 280 that there is a problem with the label 225, one or more guidelines 215 corresponding to the label 225, or a combination of these. That is, the guideline(s) 215 could be problematic, the label 225 could be problematic, or both could be problematic. If the one or more guidelines 215 are good but the label 225 is problematic, this could be because the grader 210 was not focused or did not read or properly understand the guidelines 215 when grading. If one or more guidelines 215 are problematic, they could be vague, misleading, include wrong information, or the like.

In some embodiments, when the expert consensus label 250 and the label 225 are not in agreement, the consensus count 255 can represent a degree of mismatch between the expert consensus label 250 and the label 225. For example, if twenty experts 240 disagree with the label 225, this is a larger mismatch than if only ten experts 240 disagree with the label 225. The consensus count 255 can therefore be used to indicate a priority of importance. For instance, it may be considered more important to fix a label 225 or its corresponding guideline(s) 215 if twenty experts 240 disagree with the label 225 versus if only ten experts 240 disagree with the label 225.

An additional comparison operation 285 can be used to determine if the label 225 is problematic or if the problem lies with one or more guidelines 215. In some embodiments, the comparison operation 285 may involve manual examination of the label 225 and the corresponding guidelines 215. If the label 225 is determined to be problematic, the label 225 can be marked to be returned to the grader pool 265 where a grader 210 can reassess the data sample 205. If the label 225 is determined to be acceptable based on the guidelines 215, one or more identification operations 290 can be used to identify which of the guidelines 215 is problematic. Once identified, the problematic guideline(s) 215 can be corrected as new guidelines 295. The new guidelines 295 can be used subsequently by graders 210 in the grader pool 265 for assessment of new data samples 205 and/or for reassessment of the data samples 205 that were indicated as problematic.

In some embodiments, the data samples 205 that have problematic labels 225 can be used for real-time training of graders 210. For example, the data samples 205 can be randomly inserted in a task queue for the graders 210. A grader 210 can be directed to guidelines 215 if the grader 210 generates a wrong label and be given an explanation of why a different label is more appropriate than the one chosen by the grader 210.

The automated operations and functions shown in FIGS. 2A and 2B can be implemented in an electronic device 101, server 106, or other device in any suitable manner. For example, in some embodiments, these operations can be implemented or supported using one or more software applications or other software instructions that are executed by the processor 120 of the electronic device 101, server 106, or other device. In other embodiments, at least some of these operations can be implemented or supported using dedicated hardware components. In general, these operations can be performed using any suitable hardware or any suitable combination of hardware and software/firmware instructions.

Although FIGS. 2A and 2B illustrates one example of a process 200 for improving machine learning training data quality, various changes may be made to FIGS. 2A and 2B. For example, while shown as a specific sequence of operations, various operations shown in FIGS. 2A and 2B could overlap, occur in parallel, occur in a different order, or occur any number of times (including zero times). Also, the specific operations shown in FIGS. 2A and 2B are examples only, and other techniques could be used to perform each of the operations shown in FIGS. 2A and 2B.

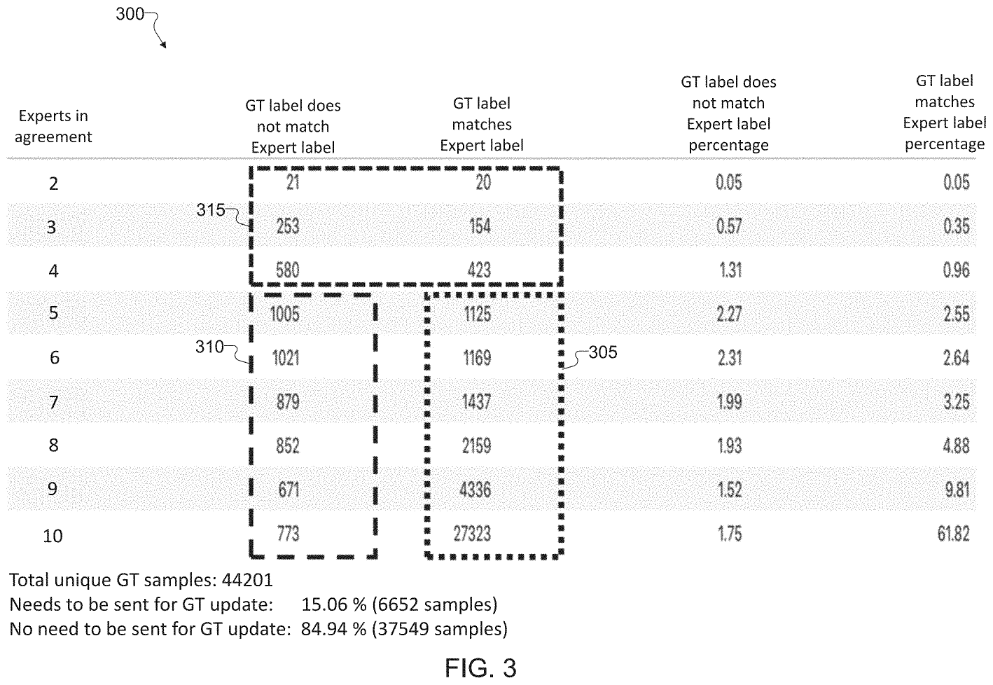

FIG. 3 illustrates example results 300 obtained during an implementation of the process 200 according to this disclosure. As shown in FIG. 3, the implementation included analysis of 44,201 data samples 205. Labels 225 were determined by graders 210 for each of the data samples 205, and the process 200 was used to obtain expert labels 235 for each data sample 205. In this example, ten experts 240 were used to obtain the expert labels 235 and the threshold value, as used in the comparison operation 260, was selected to be five. Among the ten experts 240 were seven random forest classifiers, one gradient boosted classifier, and two support vector machine classifiers.

Boxes 305 and 310 indicate counts of data samples 205 in which at least a threshold number of experts 240 (five or more experts 240 in this example) were in agreement with each other (meaning the consensus count 255 was greater than or equal to five) as determined in the comparison operation 260. The box 305 indicates results in which the expert consensus label 250 matches the label 225 as determined in the comparison operation 270. These data samples 205 are considered to have clean labels 275 that are appropriate for training. The box 310 indicates results in which the expert consensus label 250 does not match the label 225. These data samples 205 are considered to have problematic labels 225 or guidelines 215. A box 315 indicates counts of data samples 205 in which the number of experts 240 in agreement is less than the threshold. These data samples 205 represent a lack of consensus among the experts 240 and need to be reassessed. As shown in FIG. 3, only approximately 15% of the data samples 205 are included in the boxes 310 and 315 and thus need to be reassessed. The other 85% of data samples 205 (those in the box 305) have clean labels 275 that can be used in training, which represents a significant improvement over manual grading techniques.

Although FIG. 3 illustrate examples of results obtained during an implementation of the process 200 of FIGS. 2A and 2B, various changes may be made to FIG. 3. For example, data samples can be captured and assessed and labels can be determined using different techniques, and FIG. 3 does not limit the scope of this disclosure to any particular technique. FIG. 3 is merely meant to illustrate example types of benefits that might be obtainable using the techniques described above.

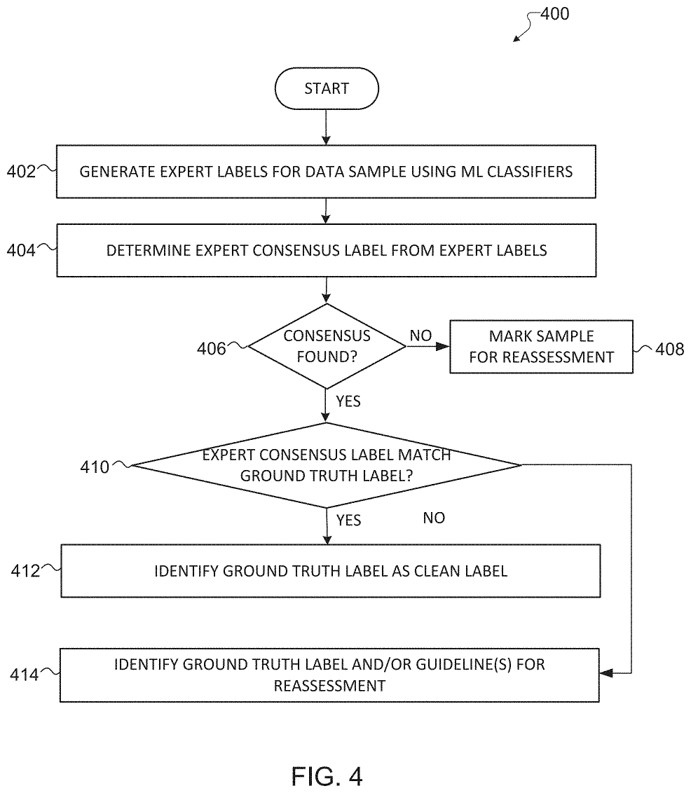

FIG. 4 illustrates an example method 400 for improving machine learning training data quality according to this disclosure. For ease of explanation, the method 400 shown in FIG. 4 is described as involving the use of the process 200 shown in FIGS. 2A and 2B and the electronic device 101 shown in FIG. 1. However, the method 400 shown in FIG. 4 could be used with any other suitable electronic device (such as the server 106 of FIG. 1) and in any other suitable system.

As shown in FIG. 4, a plurality of expert labels is generated for a sample using a plurality of machine learned classifiers at step 402. This could include, for example, the electronic device 101 generating multiple expert labels 235 for a data sample 205 using multiple experts 240 in a J-fold cross validation process 230. An expert consensus label is determined among the plurality of expert labels at step 404. This could include, for example, the electronic device 101 determining an expert consensus label 250 among the expert labels 235.

A determination is made whether or not a consensus is found among the plurality of machine learned classifiers at step 406. This could include, for example, the electronic device 101 performing the comparison operation 260 to compare a consensus count 255 of the expert labels 235 to a threshold. If a consensus is not found, the data sample 205 is marked for reassessment at step 408.

If a consensus is found, the expert consensus label is compared to a ground truth label associated with the sample at step 410. This could include, for example, the electronic device 101 performing the comparison operation 270 to determine if the expert consensus label 250 matches the label 225 associated with the data sample 205. If the expert consensus label 250 matches the label 225, the ground truth label is identified as a clean label at step 412. This could include, for example, the electronic device 101 identifying the label 225 as a clean label 275. If the expert consensus label 250 does not match the label 225, the ground truth label and/or at least one guideline is identified for reassessment at step 414. This could include, for example, the electronic device 101 identifying the label 225 and/or at least one guideline 215 for reassessment. In some embodiments, the degree of mismatch between the expert consensus label 250 and the label 225 can be used to prioritize reassessment of the label 225 and/or the at least one guideline 215.

Although FIG. 4 illustrates one example of a method 400 for improving machine learning training data quality, various changes may be made to FIG. 4. For example, while shown as a series of steps, various steps in FIG. 4 could overlap, occur in parallel, occur in a different order, or occur any number of times.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
generating, using at least one processor of an electronic device, a plurality of expert labels for a sample using a plurality of machine learned classifiers;
determining, using the at least one processor, an expert consensus label among the plurality of expert labels;
comparing, using the at least one processor, the expert consensus label to a ground truth label associated with the sample in response to determining that a consensus is found among the plurality of machine learned classifiers;
identifying, using the at least one processor, the ground truth label as a clean label in response to determining that the expert consensus label and the ground truth label match; and
identifying, using the at least one processor, the ground truth label for reassessment in response to determining that the expert consensus label and the ground truth label do not match.

2. The method of claim 1, further comprising:
identifying, among multiple guidelines corresponding to the ground truth label, at least one guideline that needs to be revised based on a degree of mismatch between the expert consensus label and the ground truth label.

3. The method of claim 2, further comprising:
determining whether to reassess the sample using the at least one guideline after the at least one guideline is revised.

4. The method of claim 2, wherein the ground truth label is generated by a grader using the multiple guidelines corresponding to the ground truth label.

5. The method of claim 1, further comprising:
determining that a lack of consensus is found among the plurality of machine learned classifiers; and
marking the sample for reassessment in response to determining that the lack of consensus is found among the plurality of machine learned classifiers.

6. The method of claim 1, wherein the machine learned classifiers are trained using multi-fold cross validation.

7. The method of claim 1, wherein the machine learned classifiers include different types of classifiers selected to reduce bias in label generation.

8. The method of claim 1, wherein the consensus is based on a largest number of matches among the plurality of expert labels.

9. The method of claim 1, wherein:
the sample is one of a plurality of samples; and
each of the samples is associated with a verbal utterance.

10. An electronic device comprising:
at least one memory configured to store instructions; and
at least one processing device configured when executing the instructions to:
generate a plurality of expert labels for a sample using a plurality of machine learned classifiers;
determine an expert consensus label among the plurality of expert labels;
compare the expert consensus label to a ground truth label associated with the sample in response to determining that a consensus is found among the plurality of machine learned classifiers;
identify the ground truth label as a clean label in response to determining that the expert consensus label and the ground truth label match; and
identify the ground truth label for reassessment in response to determining that the expert consensus label and the ground truth label do not match.

11. The electronic device of claim 10, wherein the at least one processing device is further configured to identify, among multiple guidelines corresponding to the ground truth label, at least one guideline that needs to be revised based on a degree of mismatch between the expert consensus label and the ground truth label.

12. The electronic device of claim 11, wherein the at least one processing device is further configured to determine whether to reassess the sample using the at least one guideline after the at least one guideline is revised.

13. The electronic device of claim 11, wherein the ground truth label is generated by a grader using the multiple guidelines corresponding to the ground truth label.

14. The electronic device of claim 10, wherein the at least one processing device is further configured to:
determine that a lack of consensus is found among the plurality of machine learned classifiers; and
mark the sample for reassessment in response to determining that the lack of consensus is found among the plurality of machine learned classifiers.

15. The electronic device of claim 10, wherein the machine learned classifiers are trained using multi-fold cross validation.

16. The electronic device of claim 10, wherein the machine learned classifiers include different types of classifiers selected to reduce bias in label generation.

17. The electronic device of claim 10, wherein the consensus is based on a largest number of matches among the plurality of expert labels.

18. The electronic device of claim 10, wherein:
the sample is one of a plurality of samples; and
each of the samples is associated with a verbal utterance.

19. A non-transitory machine-readable medium containing instructions that when executed cause at least one processor of an electronic device to:
generate a plurality of expert labels for a sample using a plurality of machine learned classifiers;
determine an expert consensus label among the plurality of expert labels;
compare the expert consensus label to a ground truth label associated with the sample in response to determining that a consensus is found among the plurality of machine learned classifiers;
identify the ground truth label as a clean label in response to determining that the expert consensus label and the ground truth label match; and
identify the ground truth label for reassessment in response to determining that the expert consensus label and the ground truth label do not match.

20. The non-transitory machine-readable medium of claim 19, further comprising instructions that when executed cause at least one processor to identify, among multiple guidelines corresponding to the ground truth label, at least one guideline that needs to be revised based on a degree of mismatch between the expert consensus label and the ground truth label.
